(19) United States
(12) Patent Application Publication
(10) Pub. No.: US 2011/0031750 A1
(43) Pub. Date: Feb. 10, 2011

(54) WAVE POWERED ELECTRICITY GENERATION

(76) Inventor: Peter Alfred Kreissig, Steamboat Springs, CO (US)

Correspondence Address: HENSLEY KIM & HOLZER, LLC, 1660 LINCOLN STREET, SUITE 3000, DENVER, CO, 80264, US

(21) Appl. No.: 12/536,873

(22) Filed: Aug. 6, 2009

(51) Int. Cl. F03B 13/18

(52) U.S. Cl. 290/53

(57) ABSTRACT

The generation of electricity using waves on a body of water is disclosed herein. Two flotation devices floating on a body of water are each attached to cables that extend to anchors at an ocean/sea/lake floor. The cables slideably attach to the anchors, further extend along the floor, and then connect to a stationary generator station located on or near land adjacent the body of water. As the waves propagate on the water, each of the flotation devices moves in an elliptical fashion as each wave passes underneath each flotation device. The periodic oscillatory motion of each of the flotation devices causes the cables to likewise periodically retract and extend from the station. The periodic retraction/extension of the cables provides the mechanical power necessary for the station to generate electricity. The station includes mechanical and electrical equipment associated with the wave-powered electricity generation system, including an electrical generator.

### BACKGROUND

Developing new and improved systems and methods for generating energy from renewable sources is part of managing the current global energy consumption rate and accounting for future increases in energy consumption. Sources of renewable energy may include without limitation water-powered energy, wind-powered energy, solar energy, and geothermal energy. Of the current practical renewable energy sources, water-powered energy, and specifically wave-powered energy may hold the most promise for developing substantial renewable energy sources to meet growing global energy needs.

Ocean waves contain considerable amounts of energy, and given the vast areas available for harvesting such energy, wave-powered energy technology represents a significant renewable energy source. Numerous systems have been developed in an attempt to efficiently capture the energy of waves; however, no prior conceived systems or methods have achieved the efficiency and/or cost-effectiveness required to make wave-powered energy a particularly viable alternative energy source.

Wave energy recovery systems operate in hostile marine or freshwater environments. Such environments are prone to violent storms and the deleterious impact of salt water, plant life, and animal life. Further, due to the offshore location of such systems, a successful system includes means for delivering energy output to shore, which is nontrivial. Still further, existing wave-power units have typically been complicated, prohibitively expensive, and not portable.

### SUMMARY

Implementations described herein address the foregoing problems by providing a system and method for generating electricity using waves on a body of water. Flotation devices floating on a body of water are each attached to cables that extend to anchors at the ocean/sea/lake floor. The cables movably attach to the anchors and further extend along the floor to connect to a stationary generator station located on or near land adjacent the body of water. As the waves propagate on the water, each of the flotation devices moves in a generally elliptical fashion as each wave passes underneath each flotation device. The periodic oscillatory motion of each of the flotation devices causes the cables to likewise periodically retract to and extend from the station. The periodic retraction/extension of the cables provides mechanical power for the station to generate electricity. The station includes mechanical and electrical equipment associated with the wave-powered electricity generation system, including an electrical generator. Other implementations are also described and recited herein.

### BRIEF DESCRIPTION OF THE DRAWINGS

FIG. 1 illustrates an elevation view of an example wave-powered electricity generation system with a detail view of an example on-shore generator station.

FIG. 2 illustrates a plan view of an example wave-powered electricity generation system with a detail view of an example on-shore generator station.

FIG. 3 illustrates a perspective view of an example on-shore generator station that may be used in conjunction with a wave-powered electricity generation system.

FIG. 4 illustrates a plan view of an example on-shore generator station that may be used in conjunction with a wave-powered electricity generation system.

FIG. 5 illustrates a plan view of an example array of 26 wave-powered electricity generation systems.

FIG. 6 illustrates a plan view of an example stacked array of 52 wave-powered electricity generation systems.

FIG. 7 illustrates example operations for generating electrical power using surface waves in a body of water.

### DETAILED DESCRIPTIONS

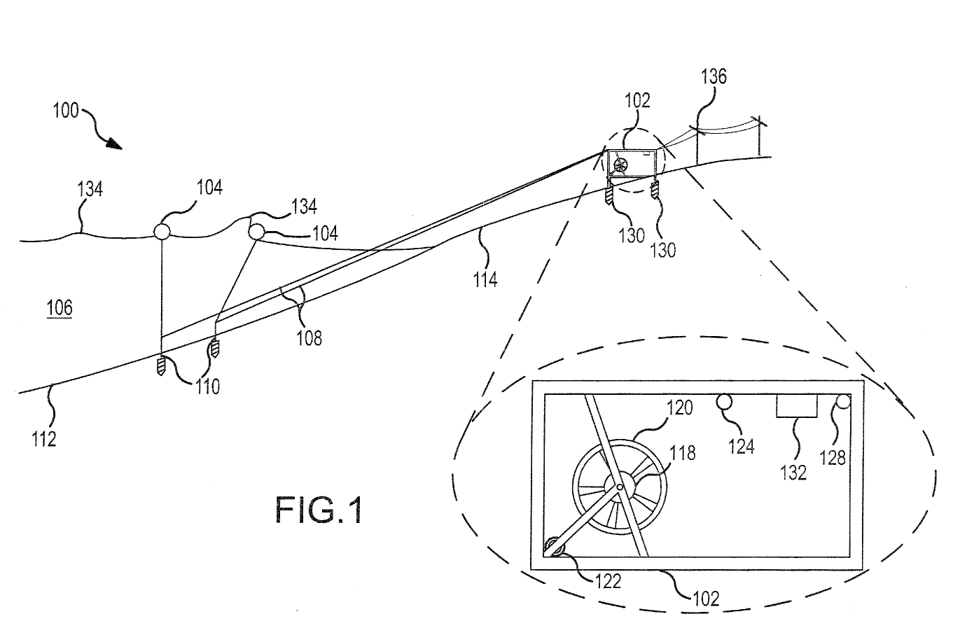

FIG. 1 illustrates an elevation view of an example wave-powered electricity generation system 100 with a detail view of an example on-shore generator station 102. Two flotation devices 104 (e.g., buoys) floating on a body of water 106 are each attached to cables 108 that extend to anchors 110 at the ocean/sea/lake floor 112. The cables 108 movably attach to the anchors 110 and further extend along the floor 112 and then ground 114 to the on-shore generator station 102 located on land near the shore of the body of water 106 (e.g., the on-shore generator station 102 could be fully or partially submerged, or positioned on dry land, as shown in FIG. 1).

As surface waves 134 propagate on the body of water 106, each of the buoys 104 moves in a generally elliptical fashion as each surface wave 134 passes underneath each buoy 104. More specifically, as a surface wave 134 approaches a buoy 104, the buoy 104 is pushed forward in front of the surface wave 134. The buoy 104 is then pushed over the top of the surface wave 134. As the surface wave 134 passes by the buoy 104, the buoy 104 follows the surface of the body of water 106 downward and backward behind the surface wave 134 and back to its original position. This process repeats as each surface wave 134 passes underneath each buoy 104.

The periodic oscillatory motion of each of the buoys 104 causes the cables 108 to likewise periodically retract and extend from the on-shore generator station 102. The periodic retraction/extension of the cables 108 provides the mechanical power necessary for the system 100 to generate electricity.

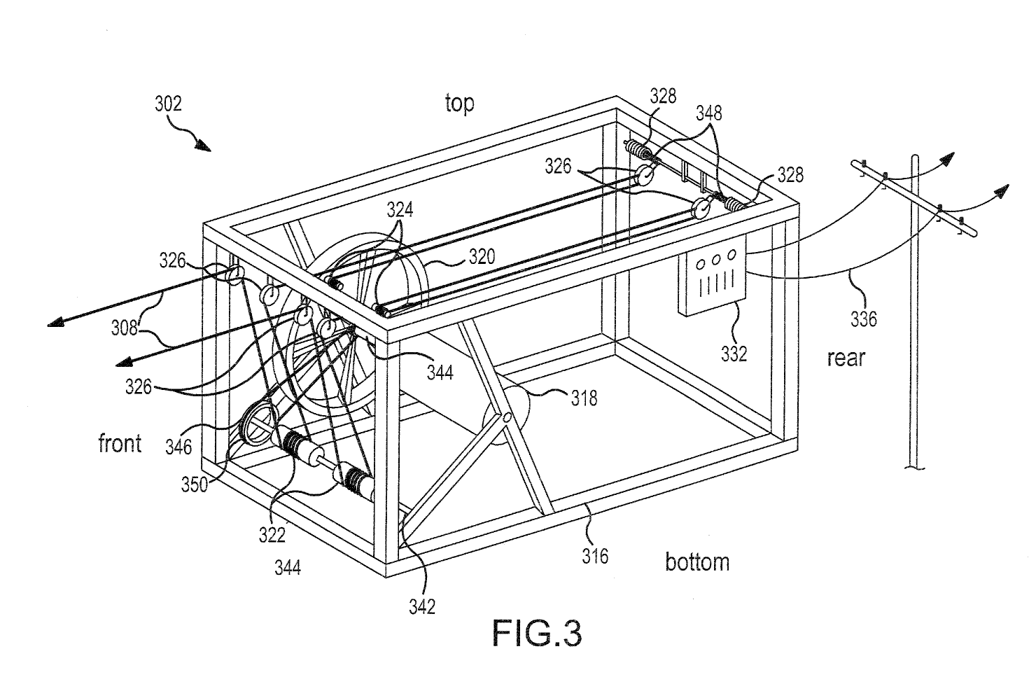

The on-shore generator station 102 includes an enclosure that houses mechanical and electrical equipment associated with the wave-powered electricity generation system 100. The housed mechanical and electrical equipment may include a generator 118, a flywheel 120, clutched spools 122, winches 124, retractors 128, and a control panel 132, which are all discussed with more specificity with regard to FIG. 3. Electrical transmission lines 136 may extend from the on-shore generator station 102 to an electricity distribution center or an end-user of the electricity. Note: the cables 108 are not shown in the detail view of the on-shore generator station 102.

In some implementations, the station 102 is anchored to the ground 114 to prevent the station 102 from shifting. Some example forces that may cause the station 102 to shift include without limitation forces from the cables 108, weather-related forces, force of gravity if the station 102 is mounted on a substantial slope, and forces caused by motion of the mechanical equipment moving inside the station 102. In an example implementation, the station 102 is anchored by laying a concrete foundation on the ground and securing the station 102 to the foundation. Alternatively, the station 102 may be anchored by driving piers 130 into the ground 114 and securing the station 102 to the piers 130. Still further, guy-wires anchored to positions on the ground 114 near the station 102 can extend and attach to the station 102. In other implementations, the weight of the station 102 is sufficient to prevent the station 102 from shifting and thus the station 102 is not anchored to the ground 114. While the station 102 is shown on anchored to the ground 114 outside of the body of water 106 in FIG. 1, the station 102 may also be located partially or totally in the body of water 106 anchored either on the ground 114 and/or on the ocean/sea/lake floor 112.

Buoys 104 can be any floatable device with sufficient buoyancy to cause retraction/extension of the cables 108 when a wave passes underneath the buoys 104. Further, the buoys 104 can be of any size and shape, including for example spherical, cylindrical, pyramidal, and prismatic. In one example implementation, the buoys are spherical with a diameter of 5 feet, although other sizes and shapes may be employed. Still further, the buoys 104 may be constructed of any hollow material that is rigid enough to hold its shape and not significantly water-permeable. For example, the buoys 104 may include hollow, water-tight metal (e.g., steel and iron) or plastic (e.g., polypropylene and polyvinyl chloride) components. In other implementations, the buoys 104 are constructed of any solid material that has greater buoyancy than water (e.g., foam and polystyrene). In still other implementations, the buoys 104 may incorporate both hollow and solid materials (e.g., a hollow metal buoy filled with foam).

The buoys 104 may include additional structural, decorative, and/or safety devices that are unrelated to the primary purpose of the buoys 104. For example, the buoys 104 may incorporate a metal tower extending into the air above the buoys 104 to improve visibility of the buoys 104 and/or allow for the attachment of auxiliary equipment (e.g., lights or flags) to the buoys 104. Still further, wave-powered electricity generation buoys 104 may be simultaneously used for other purposes, e.g., navigational aids, markers, mooring devices, weather monitoring, data collection, fishing traps, and so on.

The cables 108 are any long structure with sufficient tensile strength to retract and extend with the movements of the buoys 104 without exceeding the operating limits of the cables 108 (e.g., wire rope or metal chain). In an implementation utilizing galvanized steel wire rope, the rope diameter may be ⅜″. The cables 108 terminate at the buoys 104 with a secure fastening device. In some implementations, the fastening device allows the cables 108 to be repeatedly detached and reattached to the buoys 104 for ease of installation, maintenance, and/or removal of the wave-powered electricity generation system 100. The cables 108 may terminate with loops, clamps, or clasps. In one implementation, an end of a cable 108 is wrapped around a buoy 104 and clamps back on itself to secure itself to the buoy 104. In another implementation, the buoys 104 and cables 108 are equipped with loops that may be fastened together using a carabiner or other removable clasp. In yet another implementation, one of a buoy 104 and a cable 108 is equipped with a clasp and the other of the buoy 104 and the cable 108 is equipped with a loop and the clasp and the loop are attached together.

Anchors 110 secure a moveable connection with the cables 108 to the ocean/sea/lake floor 112. The moveable connection may include pulleys or loops through which the cables 108 pass. Further, the anchors 110 can include piles of either reinforced concrete, wood, or steel driven into the ocean/sea/lake floor 112 or screws drilled into the ocean/sea/lake floor 112 to secure the anchors 110. In another implementation, the anchors 110 are attached to an object of sufficient mass that stays in position by merely resting on the ocean/sea/lake floor 112 without any attachment to the ocean/sea/lake floor 112 (i.e., a deadweight anchor).

Various components of the buoys 104, cables 108, and/or anchors 110 may be coated to prevent corrosion caused by constant contact with the body of water 106. For example, the coating can include paint, conversion coatings (e.g., anodizing, chromate coating, and phosphate coating), galvanizing, and plating. Alternatively, or in combination with the coatings, materials may be selected for the various components of the buoys 104, cables 108, and/or anchors 110 that are inherently resistant to corrosion (e.g., plastics, stainless steel, and aluminum). Corrosion resistance is especially critical when the body of water 106 used for the wave-powered electricity generation system 100 is seawater or brackish water.

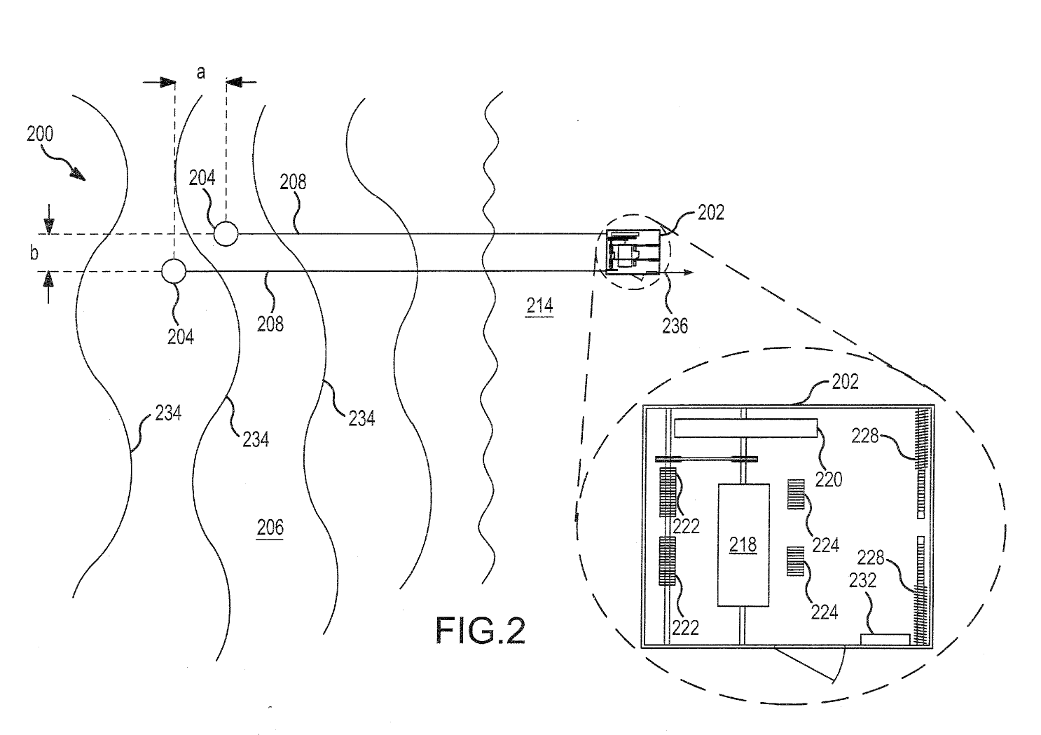

FIG. 2 illustrates a plan view of an example wave-powered electricity generation system 200 with a detail view of an example on-shore generator station 202. Two flotation devices 204 (e.g., buoys) floating on a body of water 206 are attached to cables 208 that extend to the on-shore generator station 202 located on land 214 adjacent the body of water 206. As surface waves 234 propagate on the body of water 206, each of the buoys 204 moves in an elliptical fashion as each surface wave 234 passes underneath each buoy 204. The periodic oscillatory motion of each of the buoys 204 causes the cables 208 to likewise periodically retract and extend from the on-shore generator station 202. The periodic retraction/extension of the cables 208 provides the mechanical used to generate electricity.

In some implementations, each of the two buoys 204 and associated cables 208 are offset from one other in both in a direction parallel to the cables 208 and a direction perpendicular to the cables 208 along the body of water 206 surface. The buoys 204 are offset by distance “a” in the direction parallel to the cables 208 along the body of water 206 surface to provide a more uniform mechanical power delivery to the on-shore generator station 202. More specifically, by offsetting the buoys 204, a position of one buoy 204 within its elliptical motion is different from the position of the other buoy 204 within its elliptical motion. Assuming the station 202 only generates electrical power when a cable 208 is extended from the station 202 and since each of the two buoys 204 cause extension of its associated cable 208 at different times (e.g., in opposing phases of oscillation), consistency of the mechanical power delivery to the station 202 is improved. In one implementation, the buoys 204 are separated by a distance equal to half the average distance between surface waves 234 on the body of water 206 to maximize consistency of the mechanical power delivery to the station 202.

The buoys 204 may also be offset from one another by distance “b” in a direction perpendicular to the cables 208 along the body of water 206 surface. This offset provides space between each buoy 204 and its associated cable 208. As a result, the buoys 204 and cables 208 are less likely to impact one another and the cables 208 are less likely to become entangled with one another. In one example implementation, the each buoy 204 and its associated cable 208 is separated by 20 feet perpendicular to the cables 208.

In some implementations, locations of anchors associated with the buoys 240 is adjustable. For example, deadweight anchors may be filled with sufficient gas to overcome their mass with buoyancy and repositioned. In another example, while the anchors do not move, the point at which the cables 208 meet the deadweight anchors is adjustable. Generally, since the relative position of the anchors corresponds to the relative position of the buoys 204, repositioning the anchors results in tuning distances “a” and/or “b”. Distance “a” may be tunable to adjust for period variations in the surface waves 234 or tune a phase difference between oscillations of each of the two buoys 204. Distance “b” may be tunable to compensate for rough waters or a different spacing and/or arrangement of on-shoe generator stations 202. Other reasons for tuning distances “a” and “b” are contemplated herein.

The on-shore generator station 202 includes an enclosure that houses mechanical and electrical equipment associated with the wave-powered electricity generation system 200. The housed mechanical and electrical equipment may include a generator 218, a flywheel 220, clutched spools 222, winches 224, retractors 228, and a control panel 232, which are all discussed with more specificity with regard to FIG. 3. Electrical transmission lines 236 may extend from the on-shore generator station 202 to an electricity distribution center or an end-user of the electricity. Note: the cables 208 are not shown in the detail view of the on-shore generator station 202. While the station 202 is shown on anchored to the ground 214 outside of the body of water 206 in FIG. 2, the station 202 may also be located partially or totally in the body of water 206 anchored either on the ground 214 and/or on the ocean/sea/lake floor 212.

FIG. 3 illustrates a perspective view of an example on-shore generator station 302 that may be used in conjunction with a wave-powered electricity generation system. The example on-shore generator station 302 includes an enclosure that houses mechanical and electrical equipment associated with a wave-powered electricity generation system. The example enclosure shown in FIG. 3 includes a framework 316 and a protective skin (not shown). More specifically, the framework 316 includes structural components that are arranged in a manner that provides the enclosure enough support to remain intact when stressed. Example stresses on the framework 316 include without limitation: weight of the mechanical and electrical equipment within the station 302, forces caused by the moving mechanical equipment within station 302, forces caused by extending/retracting cables 308, forces exerted on the station 302 when it is installed and/or removed, forces caused by severe weather, and forces caused by impact from debris or other objects external to the station 302. Further, the framework 316 may provide mounting points for the various mechanical and electrical equipment within the station 302.

In the implementation shown in FIG. 3, the framework 316 generally takes the form of a boxed shape with additional cross members providing extra support for the generator 318 and flywheel 320, which may be quite heavy. However, the framework 316 may take any form that provides enough room for the electrical and mechanical equipment within the station 302 while providing enough strength to resist any known or foreseeable stresses (e.g., the example stresses listed above). The framework 316 can be constructed of either wood, metal (e.g., steel and aluminum), or fiberglass, however any other construction that meets strength and space requirements is contemplated herein.

The protective skin (not shown) wraps around the inside and/or outside of the framework 316 components thereby creating the enclosure. Further, the protective skin may enhance the strength of the framework 316 or in some implementations, the protective skin is sufficiently strong to serve as the framework 316. The protective skin may provide the mechanical and electrical equipment a total or partial shield from weather events (e.g., wind, rain, snow, and hail). Further, the protective skin may be waterproof and thus prevent water from entering the enclosure in the event of a storm surge. Still further, the protective skin may hide and/or secure the mechanical and electrical equipment to discourage theft.

In one implementation, the station 302 is equipped with one or more doors or windows to aid access and comfort of maintenance personnel working on the mechanical and electrical equipment inside the station 302. The doors and windows are secured to prevent unauthorized personnel from accessing the interior of the station 302. The station 302 is equipped with a variety of climate control systems, including for example, air conditioning, heat, and air circulation. Apertures in the enclosure are provided for cables 308 extending out to flotation devices (e.g., buoys) and electrical transmission lines extending out to a power grid or an end-user of the power generated within the on-shore generator station 302.

The protective skin can be constructed of wood (e.g., plywood), corrugated metal (e.g., steel and aluminum), or corrugated fiberglass, however any other construction that meets strength and space requirements is contemplated herein. In one implementation, standard shipping containers or semi-trailers are utilized for the enclosure. If additional features are required, the standard shipping containers or semi-trailers are modified to meet the requirements of the station 302 (e.g., addition of doors/windows/other apertures, addition of supplemental framework 316, addition of a climate control system). Using standard shipping containers or semi-trailers to create the enclosure can improve the portability and cost effectiveness of the station 302.

The cables 308 extending from buoys floating in the body of water enter the station 302 though apertures in the protective skin near a top-front of the station 302. The cables 308 extend through a first set of pulleys 326 mounted near the top-front of the station 302 and extend downward to clutched spools 322 near a bottom-front of the station 302. The clutched spools 322 are mounted on a common spool drive shaft 342 that extends across the station 302 between framework 316 members. The cables 308 wrap around the clutched spools 322 and then extend upward and through a second set of pulleys 326 mounted near the top-front of the station 302.

The cables 308 then extend along a top of the station 302 toward retractors 328 mounted near a top-rear of the station 302. The retractors 328 each include a torsion spring and a spool. A set of retractor cables 348 are each wrapped around a corresponding spool of the retractors 328 and attach to a third set of pulleys 326. The torsion spring pulls the third set of pulleys 326 toward the retractors 328. The cables 308 extend through the third set of pulleys 326 and return along the top of the station 302 back toward the front of the station 302 to winches 324 mounted near the top-front of the station 302. The cables 308 each wrap around a winch drum and terminate.

The cables 308 wrapped around the clutched spools 322 are each adapted to engage the driveshaft 342 if rotated in a first direction and slip with respect to the driveshaft 342 if rotated in a second direction. As a result, periodic extension and retraction of the cables 308 caused by oscillation of the buoys is translated to rotation of the driveshaft 342 in one direction. The clutched spools 322 are low-flanged or unflanged cylinders with an internal or external clutch that unidirectionally engages with the driveshaft 342. The clutch can be fluid operated (e.g., hydraulic) or mechanical (e.g., a ratcheting clutch).

In some implementations, the unidirectional rotation of the driveshaft 342 is then transferred to one or more flywheels 320. Each flywheel 320 is a mechanical device that uses a moment of inertia as a storage device for rotational energy. The flywheel 320 resists changes in its rotational speed, which steadies rotation of the driveshaft 342 when a fluctuating torque is applied by the cables to the driveshaft 342. Here, torque is only applied to the driveshaft 342 when one or more clutched spools 322 are rotating in an engaged direction. Since the cables 308 periodically extend and retract, the torque likewise is periodically applied to the driveshaft 342. As such, each flywheel 320 steadies the rotational motion of the driveshaft 342.

The unidirectional rotation of the driveshaft 342, in some implementations steadied by the flywheel(s) 320, is then transferred to one or more generators 318. Each generator 318 is a device that convert the rotational energy of the driveshaft 342 into electrical energy, generally using electromagnetic induction (i.e., by using mechanical energy to force electrical charges to move through an electrical circuit).

In FIG. 3, the generator 318 and the flywheel 320 each share a common generator drive shaft 344 near a middle-front area of the station 302. The generator 318 may either be mounted to the framework 316 or to a pad (e.g., a concrete pad or steel frame) on the bottom of the station 302. The spool drive shaft 342 and the generator drive shaft 344 are equipped with drive pulleys 346 connected together with a tensioned and/or toothed belt 350. As a result, motion of the spool drive shaft 342 causes motion of the generator drive shaft 344, which in turn causes motion of the generator 318, which produces power.

Various other number and orientations of driveshafts are contemplated to connect the clutched spools 322, flywheel 320, and generator 318 together. In one example implementation, the clutched spools 322, flywheel 320, and generator 318 are connected together via one long driveshaft. In implementations where two or more driveshafts are used, the driveshafts may be connected together using a gear-drive, belt-drive, chain-drive, or other speed-torque converter. The speed-torque converter transfers the rotational energy of a first driveshaft rotating at a high speed to a second driveshaft that rotates more slowly, but with a higher torque, or vice versa.

For example, the energy imparted to a first driveshaft by the clutched spools 322 may result in a low speed, but high torque rotational energy of the first driveshaft. However, the generator 318 operates more efficiently with a higher speed input, even if that input has a lower torque. Therefore, the speed-torque converter transfers the rotational energy from the first driveshaft to a second faster rotating driveshaft connected to the generator 318.

Belt-drives or chain-drives may be used to perform speed-torque conversion or merely transfer rotational energy from one driveshaft to another driveshaft without any speed-torque conversion. The belt-drives and chain-drives include pulleys or sprockets on each driveshaft and a belt or chain wrapped around each of the pulleys or sprockets. A ratio of pulley diameters determines the amount of speed-torque conversion. A transfer of power between two pulleys or sprockets with the same diameter results in no speed-torque conversion.

The on-shore generator station 302 may also include a variety of pulleys and spools to route the cables 308 in a useful manner. For example, the cables 308 may be routed overhead to allow easier access to the electrical and mechanical equipment within the on-shore generator station 302.

The retractors 328 maintain a minimum tension within the cables 308 when the clutched spools 322 are rotating in a direction that does not engage the driveshaft 342. This prevents slack from forming in the cables 308 and causing the cables 308 to tangle with one another or other electrical or mechanical equipment. The retractors 328 may include extension or torsion springs that apply that maintain tension in the cables 308. In an example implementation utilizing a torsion spring, the cable 308 extends through a pulley 326 that is connected to another cable that is wrapped around a spool that is connected to a shaft. The spring is also connected to the shaft and when rotated from its natural state, the torsion spring applies a force to the shaft that keeps tension in the cable wrapped around the spool and thus tension in the cable 308 that extends through the pulley. In an example implementation utilizing extension springs, the pulley 326 is fitted to the cable 308 and the extension spring is configured to pull on the pulley 326. A manual or automatic adjustor may adjust the tension supplied by the retractors 328 on the cable 308. In an implementation utilizing a torsion spring, the adjustor preloads the spring to reduce the force applied by the spring on the cable 308.

The winches 324 adjust a length of the cables 308 in order to compensate for varying tide. At a low tide, the winches 324 retract the cables 308 so that buoys oriented at ends of the cables 308 do not drift too far from corresponding anchors on the ocean/sea/lake floor. Similarly, at high tide, the winches 324 extend the cables 308 so the buoys float substantially above the surface level of the body of water rather than being dragged below the surface of the body of water by the cables 308.

The winches 324 may be any mechanical device that selectively extends or retracts the cables 308. In one implementation, each cable 308 is wrapped around a winch drum and the winch drum is rotated to extend or retract each cable 308. In one implementation, a user rotates the winch drum using a hand crank. In other implementations, the winch drum is rotated using an electric, hydraulic, pneumatic, or internal combustion drive. Some implementations may include a solenoid brake or mechanical brake (e.g., a ratchet and pawl) that prevents the device from unintentionally extending the cable 308.

A control panel 332 is mounted on the side-rear area of the station 302 that controls the operation of electrically operated systems in the on-shore generator station 302. For example, the control panel 332 may control operation of the winches 324, retractors 328, clutches spools 322, and/or generator 318. More specifically, the control panel 332 may enable a user to selectively retract and extend each of the cables 308 to adjust for changes in tide. Further, the control panel 332 may enable the user to adjust the tension force of the retractors 328 to adjust for roughness in the body of water. Still further, the control panel 332 may enable the user to manually engage or disengage the clutch on each of the clutched spools 322 for maintenance or protection during a rough storm. Further yet, the control panel 332 may enable the user to turn on, turn off, or adjust a power output of the generator 318.

The control panel nay also control any lighting, climate control, and/or security systems in the station 302. Still further, the control panel may serve as a conduit through which power generated by the generator 318 passes on its way out of the on-shore generator station 302 via electrical transmission lines 336 to a power grid or an end-user. Other orientations of the control panel 332 are contemplated herein.

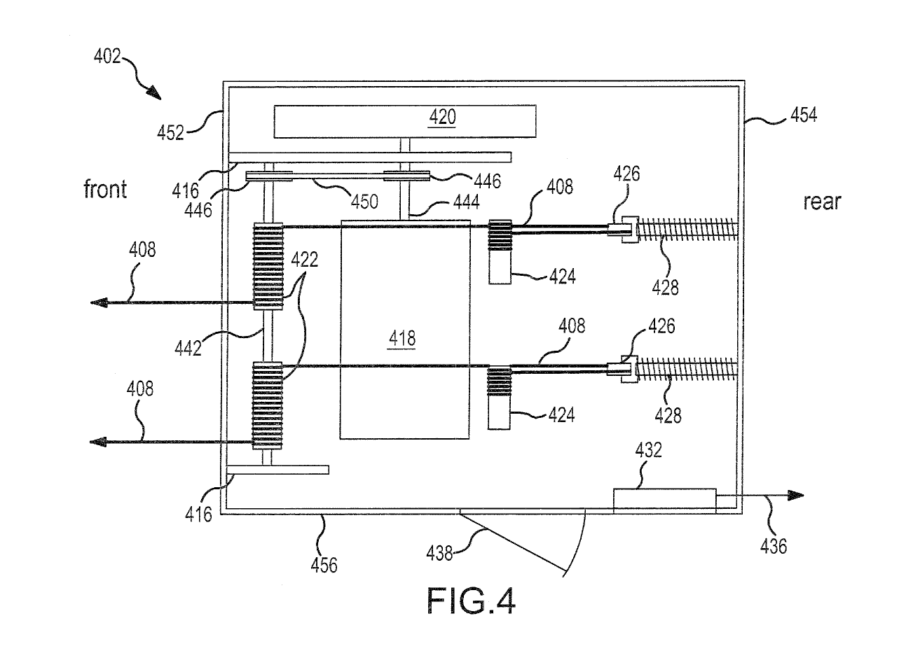

FIG. 4 illustrates a plan view of an example on-shore generator station 402 that may be used in conjunction with a wave-powered electricity generation system. Cables 408 that extend from flotation devices (e.g., buoys) floating in a body of water enter the station 402 though apertures in a front wall 452 of the station 402. The cables 408 extend to clutched spools 422 near the front wall 452 inside the station 402. The clutched spools 422 are mounted on a common spool drive shaft 442 that extends across the station 402 between framework 416 members.

The cables 408 wrap around the clutched spools 422 and then extend rearward toward retractors 428 mounted near a rear wall 454 of the station 402. The retractors 428 each include an extension spring with one end of the extension spring attached to the framework 416 at the rear wall 454 and an opposite end of the extension spring attached to a pulley 426. The extension springs pull each pulley 426 toward the rear wall 454. The cables 408 extend through the pulleys 426 and return toward a middle area of the station 402 to winches 424. The cables 408 each wrap around a winch drum and terminate at the winches 424.

A generator 418 and a flywheel 420 each share a common generator drive shaft 444. The generator 418 may either be mounted to the framework 416 or to a pad (e.g., a concrete pad or steel frame) on the bottom of the station 402. The spool drive shaft 442 and the generator drive shaft 444 are each equipped with drive pulleys 446 connected together with a tensioned and/or toothed belt 450. As a result, motion of the spool drive shaft 442 causes motion of the generator drive shaft 444, which in turn causes motion of the generator 418, which produces power. A control panel 432 is mounted on side wall 456 of the station 402 that provides power to, receives power from, and/or controls the electrical and mechanical equipment within the station 402. Electrical transmission lines 436 extend from the station 402 and provide power to an electrical grid or an end-user. Additionally, the station 402 is equipped with an access door 438 in the side wall 456 to aide access for installation, maintenance, and/or removal of mechanical and electrical equipment within the station 402.

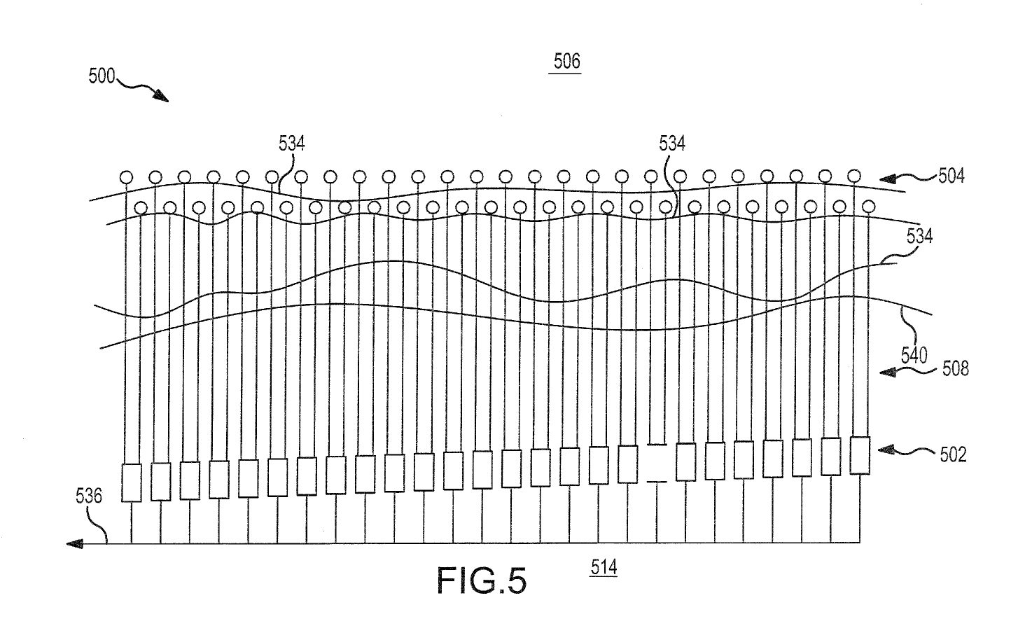

FIG. 5 illustrates a plan view of an example array of 26 wave-powered electricity generation systems 500. Twenty-six on-shore generator stations 502 are lined up and secured to ground 514 adjacent a coastline 540. Two cables 508 extend from each of the 26 stations 502 into a body of water 506 and each cable 508 connects to a flotation device 504 (e.g., a buoy) floating in the body of water 506. Surface waves 534 propagating on the body of water 056 toward the coastline 540 cause the buoys 504 to periodically oscillate. The periodic oscillation of the buoys 504 causes the cables 508 to periodically extend and retract from the stations 502.

Each pair of buoys 504 is staggered to provide a more uniform mechanical power delivery to the station 502. Further, distances between each of the buoys 504 may be selected to prevent the buoys 504 from impacting one another and/or the cables 508 from impacting or becoming entangled with one another. Electrical transmission lines extend from each of the stations 502 and join with a common transmission line 536 that connects the stations 502 to an electrical power grid and/or one or more end-users of the generated electricity.

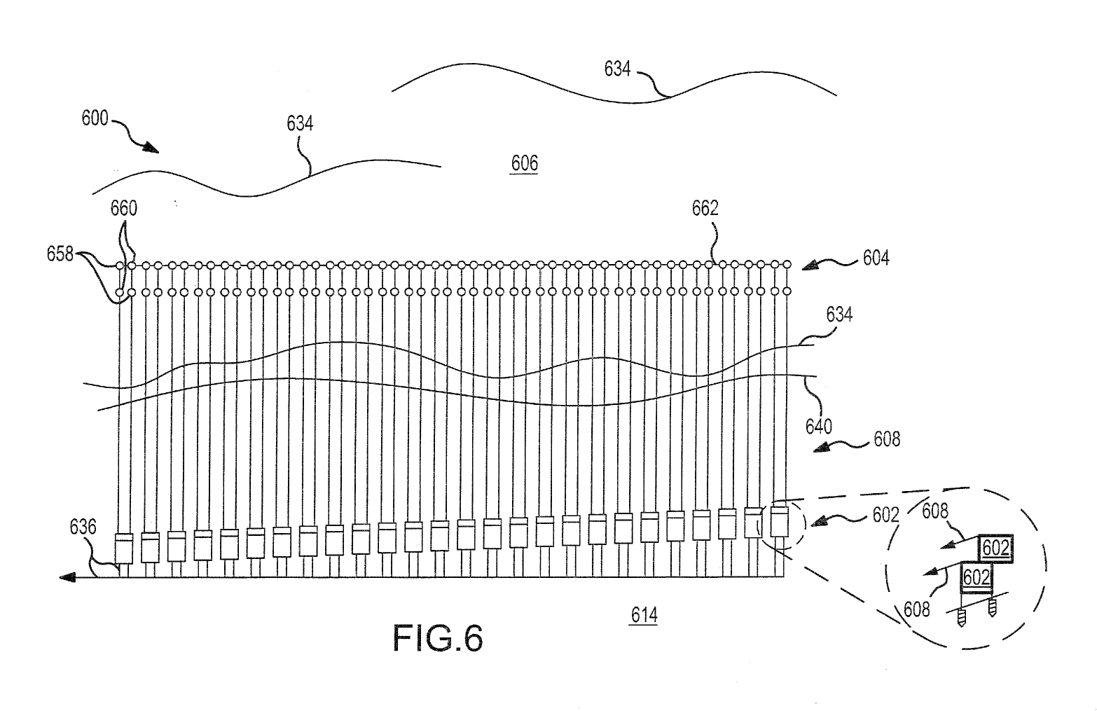

FIG. 6 illustrates a plan view of an example stacked array of 52 wave-powered electricity generation systems 600. Twenty-six on-shore generator stations 602 are lined up and secured to the ground 614 adjacent a coastline 640. Another twenty-six on-shore generator stations 602 are lined up on top of the first twenty-six stations 602 and secured to the top of the first twenty-six stations 602. In some implementations, the top twenty-six stations 602 are offset from the bottom twenty-six stations 602, as shown in the detail elevation view of generator stations 602.

The top stations may be offset from the bottom stations to improve overall stability of the stations 602 (i.e., shifting weight of a top station rearward to offset a forward pulling force exerted by the cables 608 on the top and bottom stations 602). The offset may also improve personnel access to the top and bottom stations 602 by offsetting a location of access doors on each station. Otherwise, an access ladder leading vertically to the top station may interfere with an access door for the bottom station. Still further, the cables 608 often enter a station 602 near the top of the station 602. Offsetting a top station rearward from a bottom station allows the cables 608 to enter near the top of the bottom station without any interference from the top station.

Two cables 608 extend from each of the 52 stations 602 into a body of water 606 and each cable 608 connects to a flotation device 604 (e.g., a buoy) floating in the body of water 606. Surface waves 634 propagating on the body of water 606 toward the coastline 640 cause the buoys 604 to periodically oscillate. The periodic oscillation of the buoys 604 causes the cables 608 to periodically extend and retract from the stations 602.

Each pair of buoys 604 is staggered to provide a more uniform mechanical power delivery to the station 602. Further, each pair of stations 602 (i.e., a bottom station 602 and a top station 602) utilize buoys 604 with an opposite staggered arrangement to prevent the buoys 604 from interfering with one another. For example, the leftmost pair of stations 602 in FIG. 6 are each connected to a staggered pair of buoys 604 via cables 608. The bottom station 602 is connected to a first staggered pair 658 and the top station 602 is connected to a second staggered pair 660.

Further, distances between each of the buoys 604 may be selected to prevent the buoys 604 from impacting one another and/or the cables 608 from impacting or becoming entangled with one another. In addition, the 26 buoys 604 further from the coastline 640 may be secured together using spacers 662 to prevent the buoys 604 and/or cables 608 from impacting and/or entangling with one another. In another implementation, the twenty-six buoys 604 closer to the coastline 640 may be secured together using the spacers 662 to prevent the buoys 604 and/or cables 608 from impacting and/or entangling with one another.

The spacers 662 may be flexible cables that merely prevent the buoys 604 from moving too far from one another or the spacers may be rigid with articulated attachment points to each buoy 604. The rigid spacers 662 can force the buoys 604 to maintain a desired distance from one another. In other implementations, buoys 604 closer to the coastline 640 and buoys 604 further from the coastline 640 may be secured together using the spacers 662.

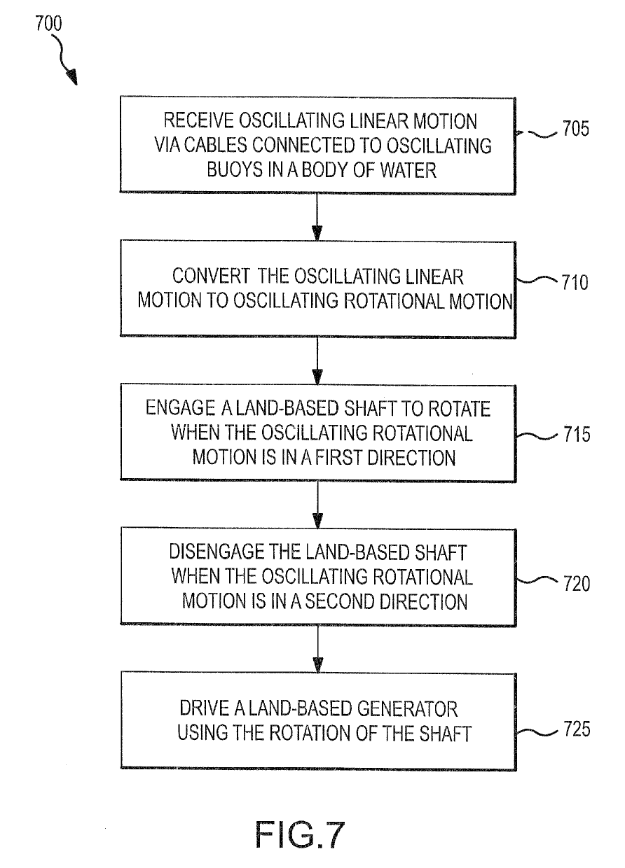

FIG. 7 illustrates example operations 700 for generating electrical power using surface waves in a body of water. A receiving operation 705 receives oscillating linear motion via cables connected to oscillating flotation devices (e.g., buoys) in the body of water. The buoys oscillate in an elliptical manner as they float over the surface waves in the body of water. The elliptical oscillation of the buoys is translated into linear oscillation of the cables that are movably attached to an ocean/sea/lake floor and extend to an on-shore generator station. A conversion operation 710 converts the oscillating linear motion to oscillating rotational motion. Each of the cables are wrapped around a spool and as the cables oscillate linearly, the spools rotate.

An engaging operation 715 engages a land-based shaft to rotate when the oscillating rotational motion is in a first direction. A disengaging operation 720 disengages the land-based shaft when the oscillating rotational motion is in a second direction. In one implementation, a clutched pulley engages the shaft in the first rotational direction and disengages the shaft in the second rotational direction. A driving operation 725 drives a land-based generator using the rotation of the shaft. The generator generates electrical power that may be delivered to a power grid or an end-user.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A system for generating electrical power using waves in a body of water, the system comprising:
a flotation device configured to oscillate with the waves, relative to a reference point;
a clutched spool configured to receive and convert the oscillation of the flotation device into rotational motion in one rotational direction;
a cable configured to transfer the oscillation of the flotation device to the clutched spool; and
a stationary generator configured to convert the rotational motion into electrical power.

2. The system of claim 1, wherein the stationary generator is located on a ground adjacent the body of water and/or a floor of the body of water.

3. The system of claim 1, further comprising:
a stationary anchor affixed to the reference point below the body of water that movably receives the cable, wherein the cable periodically extends from and retracts to the stationary anchor.

4. The system of claim 1, further comprising:
a flywheel configured to receive the rotational motion from the clutched spool, smooth fluctuations in the rotational motion, and transfer the smoothed rotational motion to the generator.

5. The system of claim 1, further comprising:
a winch attached to an end of the cable opposite the flotation device that adjusts an effective length of the cable.

6. The system of claim 1, further comprising:
a retractor attached to the cable that provides constant tension between the retractor and the flotation device.

7. The system of claim 6, wherein the retractor includes a torsion spring.

8. The system of claim 6, wherein a spring rate of the retractor is adjustable.

9. The system of claim 3, wherein the flotation device is positioned generally vertically from the stationary anchor.

10. The system of claim 3, wherein the stationary anchor is a deadweight resting on a floor of the body of water.

11. The system of claim 1, wherein the reference point below is on a floor below the body of water.

12. A system for generating electrical power using waves in a body of water, the system comprising:
a flotation device configured to oscillate with the waves relative to a to a reference point;
a cable fixably attached to the flotation device and extending substantially downward;
a stationary generating station configured to receive the cable and generate electrical power from oscillation of the flotation device;
an anchor affixed to a floor of the body of water and configured to movably receive the cable and redirect the cable to the stationary generating station.

13. The system of claim 12, wherein the flotation device occupies a space separate from the stationary generator.

14. The system of claim 12, wherein the anchor occupies a space separate from the stationary generator.

15. The system of claim 12, wherein the stationary generating station is located on a ground adjacent the body of water and/or a floor of the body of water.

16. The system of claim 12, wherein the cable extends and retracts from the stationary generating station periodically with the oscillation of the flotation device.

17. The system of claim 12, wherein the flotation device is positioned generally vertically from the anchor.

18. A system for generating electrical power using waves in a body of water, the system comprising:
two or more flotation devices configured to oscillate with the waves relative to a reference point, wherein the oscillation of one of the two or more flotation devices is out of phase with the oscillation of another of the two or more flotation devices;
two or more clutched spools, each clutched spool configured to receive and convert the oscillation of one of the two or more flotation devices into rotational motion in one rotational direction;
two or more cables, each cable configured to transfer the oscillation of one of the two or more flotation devices to one of the two or more clutched spools; and
a stationary generator configured to convert the rotational motion into electrical power.

19. The system of claim 18, wherein the two or more flotation devices are flexibly attached to one another.

20. The system of claim 18, wherein the two or more flotation devices are attached together with a rigid member having articulated attachment points to each of the two or more flotation devices.

21. The system of claim 18, wherein each of the two or more flotation devices are spaced a distance apart from one another in the body of water.

22. The system of claim 18, further comprising:
two or more anchors affixed to a stationary reference point below the body of water, wherein each of the two or more anchors movably receives one of the two or more cables.

23. The system of claim 22, wherein the two or more anchors are moveable to adjust a distance between the two or more flotation devices.

24. The system of claim 22, wherein a point where each of the two or more anchors movably receives one of the two or more cables is moveable to adjust a distance between the two or more flotation devices.

25. A method of generating electrical power using waves in a body of water, the method comprising:
receiving oscillating linear motion via a cable extending from a floatable device oscillating with the waves relative to a reference point;
converting the oscillating linear motion to rotational motion on one direction by wrapping the cable around a clutched spool; and
rotating a stationary generator connected to the clutched spool to convert the rotational motion into electrical power.

26. The method of claim 25, further comprising:
smoothing fluctuations in the oscillating linear motion applied to the clutched spool using a flywheel.

27. The method of claim 25, further comprising:
adjusting an effective length of the cable to position the floatable device generally vertically from the fixed point, wherein the fixed point is located below the body of water.

28. The method of claim 25, further comprising:
providing a constant tension on the cable as the oscillating linear motion is received by the clutched spool.

29. The method of claim 25, wherein the cable is configured to extend and retract periodically with the oscillation of the floatable device.
